(19) United States
(12) Patent Application Publication
(10) Pub. No.: US 2012/0135099 A1
(43) Pub. Date: May 31, 2012

(54) METHOD AND APPARATUS FOR RAPID MOLDING OF WIND TURBINE BLADES

(75) Inventors: Jay M. Dean, West Bend, WI (US); Geoff Wood, Sidney (CA); William J. McCormick, Mukwonago, WI (US)

(73) Assignee: MAG IAS, LLC, Sterling Heights, MI (US)

(21) Appl. No.: 13/318,926

(22) PCT Filed: May 4, 2010
(86) PCT No.: PCT/US10/33464

§ 371 Date: Dec. 7, 2011

Related U.S. Application Data
(60) Provisional application No. 61/175,243, filed on May 4, 2009.

(51) Int. Cl. B29C 43/52

(52) U.S. Cl. 425/389

(57) ABSTRACT

A compliant cover is placed over a part being molded in a molding process. The compliant cover is formed from a plurality of longitudinal cells positioned next to one another. At least one communication port is coupled to each longitudinal cell, and a source of fluid media at a preselected temperature is coupled to the communication ports whereby the longitudinal cells may be filled with the fluid media at the preselected temperature. The compliant cover may thus be used to selectively heat and cool the part being molded to decrease the time required by the part to rise to the temperature required to cure the resin in the part and to cool the part so that it can be removed from the mold.

### FIELD OF THE DEVICE

The device relates to a molding apparatus and a molding process used to rapidly mold a wind turbine blade.

### BACKGROUND

The commercial demand for wind turbine blades steadily increases as the cost of power generation continues to rise. Wind turbine blades range in size from twenty to sixty meters in length and are generally formed from glass or carbon fiber reinforced resin. The blades are hollow and are formed in two halves, an upwind half and a downwind half that splits the blade along the longitudinal axis. Once the blade halves have been formed on the molds and cured, the two halves are fastened together with adhesive to form the finished blade.

Bagging, infusion, and curing account for approximately 40% of typical mold cycle times in the manufacture of wind turbine blades. Bagging is the term used to describe the process of placing a vacuum bag on the part that has been laid up on a tool before the part is cured. The vacuum bag is used to press the part to the tool and to allow a vacuum to be drawn in the chamber formed by the bag and the tool so that the reinforcing fibers of the part can be infused with resin. In practice, the vacuum bag is formed by a plurality of 50 inch wide plastic sheets which are placed side-by-side over the blade until the entire blade surface is covered. A high-tack sealant tape is used on the edges of the individual plastic sheets to adhere the sheets together to allow the vacuum to be drawn. Placing the individual plastic sheets on the part one at a time and sealing them to one another is a time consuming process. Infusion is the process of feeding resin under a vacuum from outside of the reinforcing fibers of the part that have been laid on the tool in order to wet the fibers to form a solid part. Curing is the term used to describe the process of applying heat to the resin in order to start the curing process, waiting for the proper cure temperature to be reached, then allowing the heat of the cure to dissipate from the part before the part is removed from the tool.

Once the part is cured and cooled, the plurality of plastic sheets forming the vacuum bag are removed from the part and are discarded.

It would be desirable to decrease the mold cycle times for wind turbine blades as discussed above. It would further be desirable to employ a reusable vacuum bag that could be used several times to produce several parts. It would additionally be desirable to use a vacuum system which is more easily deployed onto the part to reduce the overall time required to make an individual blade. It would further be desirable to decrease the infusion time of the resin into the part and to decrease the curing and cooling time required for the resin.

### SUMMARY

An elastomeric material is used to fabricate a reusable vacuum bag. The vacuum bag is made approximately the size of the part with a skirt-like overhang around the edges. Because the vacuum bag is one piece, it is able to be more easily deployed onto the part than the current practice of placing individual sheets of plastic which have to be sealed to one another onto the part. The reusable plastic bag results in a reduction in consumable and disposable material, and thus reduces the long term environmental impact of the molding process by eliminating bagging film waste. The reusable plastic bag may be fabricated from a sprayable elastomer which is a relatively inexpensive material compared to silicone currently used. The material used to fabricate the reusable bag is highly durable in comparison with materials that are currently used.

Thermal control of the resin in the molding process is achieved in the following way. Heating and cooling fluids or other media is passed through the mold tool with the use of imbedded conduit lines. This is taught by the prior art. Heating and cooling media is further passed over the top surface of the part through the use of a compliant thermal chamber (CTC). The combination of the imbedded conduit lines and the CTC allows the part to be heated and cooled from both the bottom surface that is in contact with the mold and the top surface that is in contact with the CTC. Further, heat pumps may be utilized to further reduce the cost of heating and cooling the part.

After the part has been laid up on the tool and the vacuum bag is in place on the part, the CTC is laid on top of the part. The CTC comprises a soft flexible cover that can be easily deployed over the surface of the part. The CTC may be formed from ripstop polyester and Dacron materials, and these materials allow rapid thermal transfer between the heating or cooling media contained within the CTC and the top surface of the part.

Specific zones are formed within CTC to distribute thermal control media as deemed necessary by the design of the part being molded. Zones where the laminate is thicker or thinner are designed with specific thermal media volumes and flow channels to create the proper thermal control. The lightweight CTC can be deployed over the part on the tool with either automatic or manual devices. The edges of the CTC may be manually secured to the tool through the use of magnetic or mechanical coupling devices. The approximate weight of the CTC is 50 kilograms allowing for deployment of the CTC onto the part by a small number of personnel. The design of the CTC also renders it highly durable for operation and handling.

### BRIEF DESCRIPTION OF THE DRAWINGS

FIG. 1 is a perspective view of a wind turbine blade mold.

FIG. 2 is an end view of a compliant thermal chamber (CTC) in place in a wind turbine blade mold.

FIG. 3 is a plan detail view of the connection of the ribs to the hinge of the CTC.

FIG. 4 shows the CTC in the folded position in a wind turbine blade mold.

FIG. 5 is a perspective view of a portion of the CTC.

FIG. 6 is a detail view showing the vent and flap mechanism used on the longitudinal cells.

FIG. 7 is a detail view showing a fan at the inlet end of the inlet supply tube.

FIG. 8 is a perspective view of an alternate embodiment of the top of the CTC.

FIG. 9 is a graph showing temperatures and mold cycle times taken during the molding process for a baseline part, a part that is molded without using the CTC.

FIG. 10 is a graph showing temperatures and mold cycle times taken during the molding process for a part using the CTC.

### DESCRIPTION

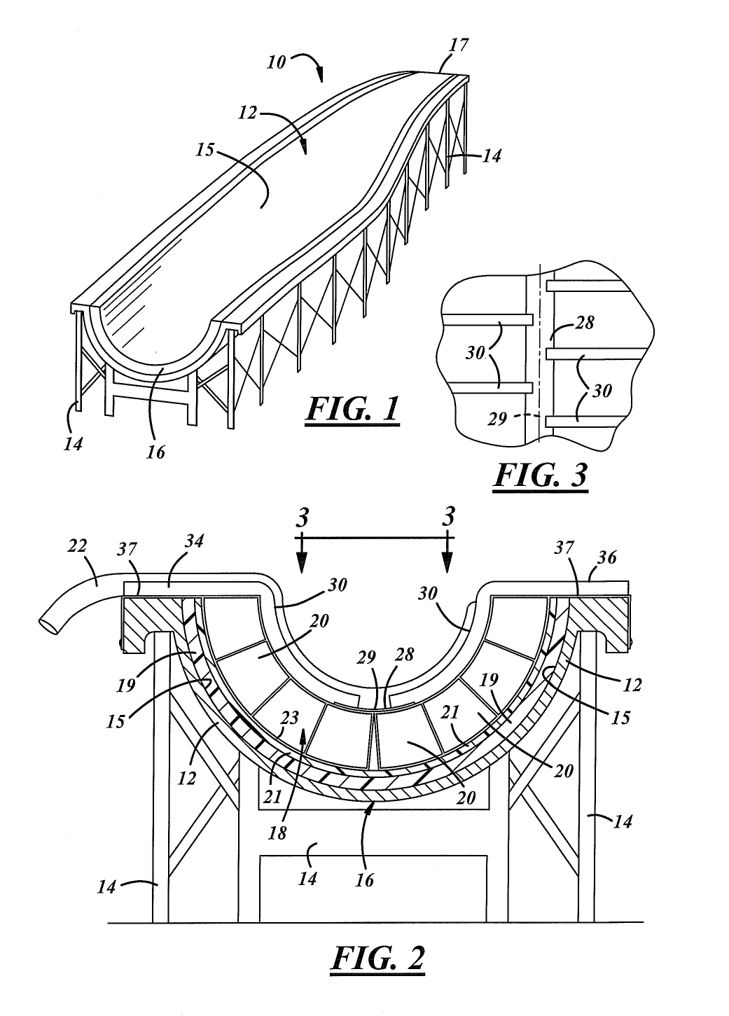

FIG. 1 is a perspective view of a wind turbine blade mold generally designated by the reference numeral 10. The mold 12 is supported by frame 14 that positions the mold with the concave surface 15 facing upward. The fiber and resin will be placed on the concave surface 15 to form a mold half. The root end of a turbine blade is the end that attaches to the hub, the root end of the turbine blade will be formed in the large end 16 of the mold. The tip of the turbine blade will be formed in the tip end 17 of the mold.

FIG. 2 is an end view of a compliant thermal chamber (CTC) 18 in position on the end 16 of the mold in which the root end of the turbine blade will be formed. A part 19 being molded is in place on the mold 12 and a vacuum bag 21 is in place on the part. The CTC 18 is placed over the vacuum bag 21. The CTC 18 comprises a plurality of inflatable longitudinal cells 20. The inflatable longitudinal cells 20 may be inflated by fluid media at a preselected temperature such as heated or cooled air which is supplied to the cells from a supply duct 22 or 41 best seen in FIG. 5. The longitudinal cells 20 may extend for the full length of the CTC, or separate individual cells 20 may be provided along the length of the CTC to provide the required heating and cooling of the part 19. FIG. 2 shows the CTC 18 in deployed position in which the bottom surface 23 of the CTC is in substantially continuous contact with the surface of the vacuum bag 21.

The CTC also includes a first set of curved stiffening ribs 30 which maintain the two halves 18A and 20 of the CTC in a curved shape which matches the curve of the concave surface 15 of the mold 12, and of the part being molded.

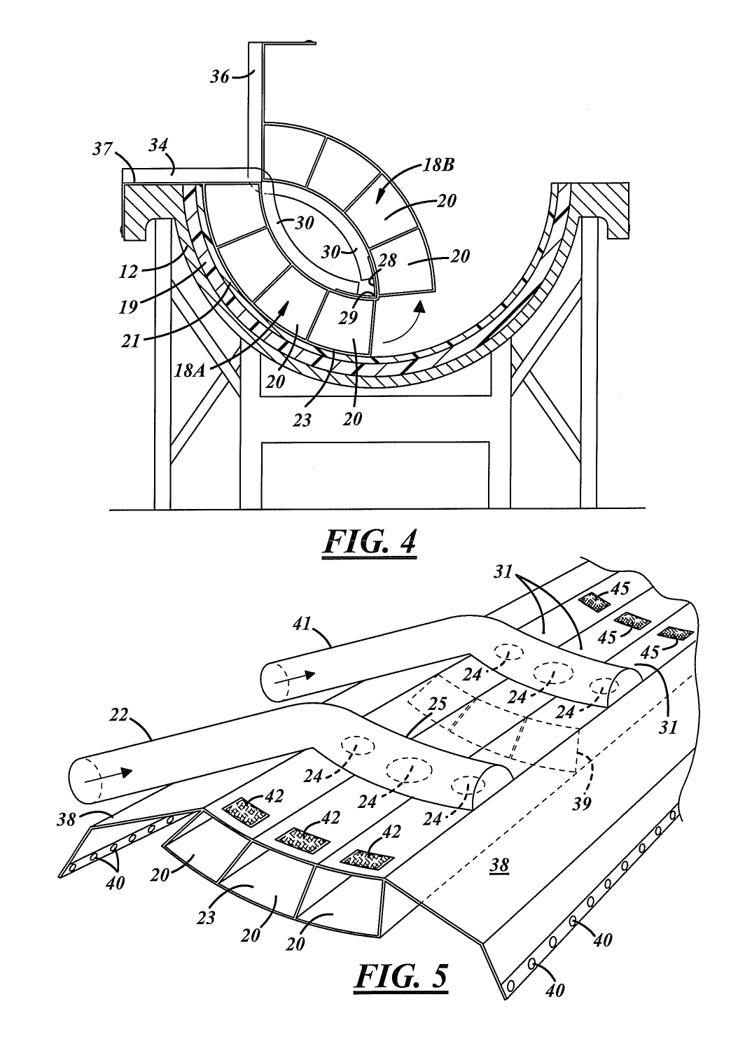

FIG. 3 is a detail view of the connection between the ribs 30 and a flexible hinge 28 having a hinge line 29 that extends longitudinally along the center of the CTC 18. The ends of the ribs 30 on the two halves of the CTC may be staggered so that they do not interfere with one another when the CTC is in the folded position as explained more fully below in connection with FIG. 4.

FIG. 4 shows the CTC 18 in the folded position in a mold 12. The flexible hinge 28 bends along the hinge line 29 to allow the two halves 18A and 18B of the CTC to be folded toward one another. FIG. 4 demonstrates how the CTC 18 can be easily put into place on a part in a mold. The folded CTC 18 is first loaded from one side of the mold 12 so that the one half 18A of the CTC supported on the vacuum bag 21 that has been positioned over the part 19. Because the CTC is fabricated from lightweight materials, it can be manually loaded into place for use on a typical wind turbine blade by as few as four personnel. A second set of straight rib sections 34 and 36 may be provided at the ends of the curved ribs 30. The second set of straight rib sections 34 and 36 function as handles to help in placement and deployment of the CTC onto the vacuum bag 21 in the mold. Personnel are able to grab the handles 36 in the position in which they are shown and pull the handles to the position shown in FIG. 2, opening the CTC to the deployed position. The straight rib sections 34 and 36 rest on the side edges 37 of the mold 12 when the CTC is deployed to properly locate the CTC relative to the mold. This places the bottom surface 23 of the CTC into contact with the vacuum bag 19 that is resting on the top surface of the part 19 in the mold cavity. The material comprising the CTC and especially the bottom skin 23 of the CTC is formed from thin material that readily transmits the thermal energy from the thermal media in the cells 20 to the surface of the vacuum bag 21, and to the part 19 that is being molded.

FIG. 5 is a perspective view of a portion of the CTC 18 showing the individual longitudinal cells 20 within the CTC. Although three longitudinal cells 20 are shown across the width of the CTC, the showing is for illustrative purposes only, and it will be understood that the CTC may comprise any number of cells 20, for example, the CTC shown in FIGS. 2 and 4 has six longitudinal cells 20 across the width. The supply duct 22 couples air from a suitable source and at a suitable temperature to a manifold 25 that feeds a plurality of communication ports 24. The communication ports 24 couple air from the manifold 25 to the longitudinal cells 20. The communication ports 24 may be of varying sizes to supply the desired amount of air from the supply duct 22 to the individual longitudinal cells 20. Each longitudinal cell 20 includes an outlet screen vent 42 downstream of the inlet port 24 to allow air which is admitted to the longitudinal cells to be vented to atmosphere. The CTC includes a side skirt 38 which has fastening elements 40 such as snaps, magnets or other mechanical fastening devices to fasten the skirt 38 to the side of the mold frame 14 to hold the CTC 18 in place.

The longitudinal cells 20 may extend for only a portion of the length of the CTC, and may be separated from additional longitudinal cells 31 by a transverse separator wall 39 that is positioned in the interior of the CTC. The additional longitudinal cells 31 have a separate supply duct 41 for admitting air to the cells via the communication ports 24. Separate screen vents 45 are provided for the longitudinal cells 31 for exhausting air from the cells 31 to atmosphere.

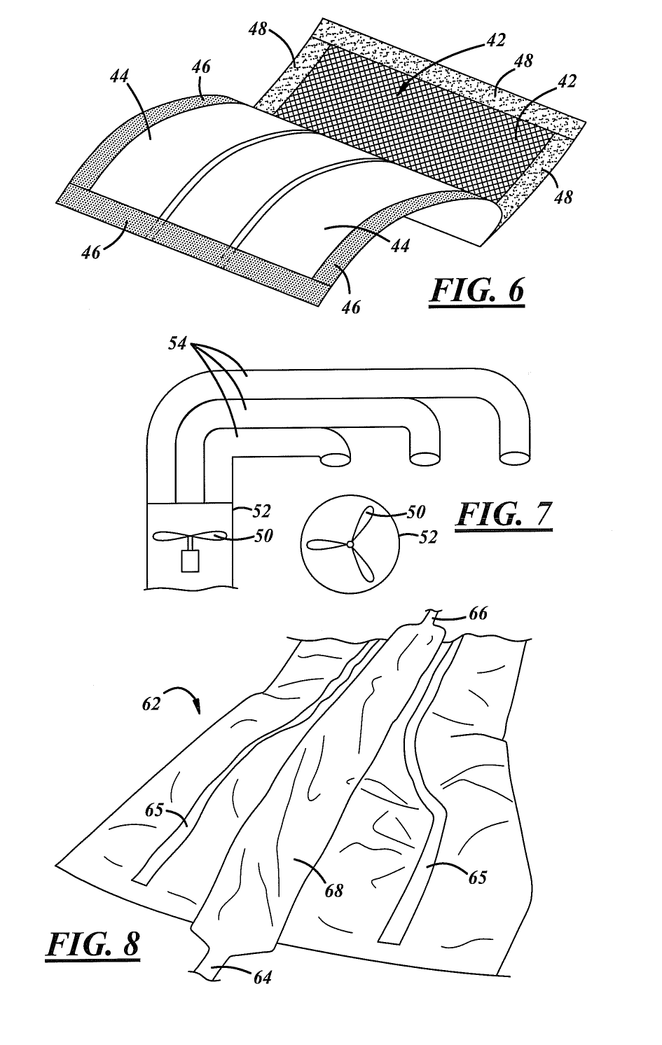

As shown in FIG. 6, each screen vent 42 may include a flap 44 which can be used to cover the vent to prevent flow therefrom or to partially open the screen vent 42 to allow a partial flow of air from the longitudinal cells 20. Each flap 44 includes a Velcro type fastening strip 46 which couples to a mating Velcro type fastening strip 48 that surrounds each of the screen vents 42. Similar flaps are provided for the screen vents 45 on the additional longitudinal cells 31.

FIG. 7 shows an embodiment in which a fan 50 is positioned at the inlet end of an inlet supply tube 52. The inlet supply tube 52 is coupled to a plurality of separate tubes 54 each of which may be coupled to a supply duct 22 or 41 for one or more longitudinal cells 20 and 31, respectively, as shown in FIG. 5.

FIG. 8 is a perspective view of the top surface of an alternate embodiment of the CTC 62. The CTC 62 is shown in an undeployed position, and curved rib sections 30 and straight rib sections 34 and 36 are not shown. Heated and cooled air is admitted to the CTC by inlets 64 and 66 at either end of the CTC 62 which are coupled to suitable sources of temperature controlled air. The inlets 64 and 66 are coupled to a manifold structure 68 which distributes the air to the cells within the CTC via communication ports, not shown, which are similar to the communication ports 24 shown in FIG. 5. Upper mesh sections 65 allow air from the interior cells of the CTC to be exhausted to the atmosphere. Vent controls similar to the flaps 44 shown in FIG. 6 may be provided along the upper mesh sections 65 to control the flow of air from the interior cells of the CTC for the desired heating or cooling effect.

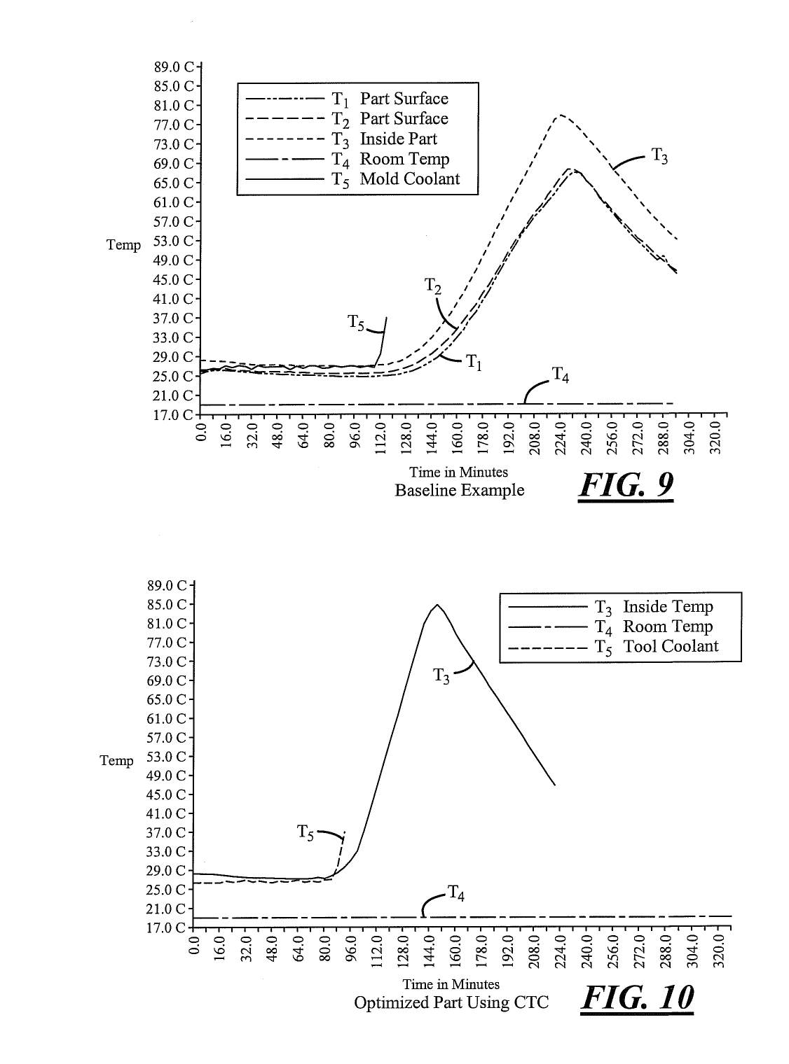

FIG. 9 is a graph showing temperatures taken during the molding process, and mold cycle times for a baseline part, a part that is molded without the CTC. The curves T1 and T2 are temperatures taken at the part surface. The curve T4 is the temperature in the room and is constant at 19° C. throughout the test period. The curve T3 is the temperature inside the part and the curve T5 shows the temperature of coolant applied to the tool. As the graph shows, the temperature T3 inside the part is relatively constant at 25° C. for 116 minutes. Thereafter, the temperature T3 inside the part begins to rise and continues rising until a maximum temperature of 79° C. is reached after a total elapsed time of 224 minutes. Thereafter, the temperature inside the part reduces to 53° C. at a total elapsed time of 296 minutes.

FIG. 10 is a graph showing the mold cycle time for the same sized part through the use of the CTC. The temperature T4 in the room is constant at 19° C. throughout the test. The temperature T3 inside the part is constant at 27° C. for 80 minutes. At the 80 minute mark, the temperature T3 starts to rise and the temperature of 85° C. is reached after a total elapsed time of 148 minutes. Thereafter, the temperature T3 in the part decreases until the temperature within the part is 47° C. after a total elapsed time of 220 minutes. The tool coolant temperature T5 is approximately constant at 27° C. for 84 minutes. The tool coolant temperature then rises to 37° C. at an elapsed time of 92 minutes. In comparing graph of FIG. 10 with the graph of FIG. 9, the temperature T3 inside the part begins to rise 28 minutes sooner using the CTC. The maximum temperature in the part is reached 76 minutes earlier using the CTC. The part is cool and ready to be removed from the mold 76 minutes sooner using the CTC.

The process timings data can be summarized as follows:

| Baseline Part | Optimized Part Using CTC |
|---|---|
| [symbol] 112 min. Infusion Complete | [symbol] 084 min. Infusion Complete |
| [symbol] 112 min. Peak Part Temperature | [symbol] 064 min. Peak Part Temperature |
| [symbol] 072 min. Cool Down | [symbol] 072 min. Cool Down |
| 296 Total Minutes | 220 Total Minutes |

Using the data above, the following comparisons can be made. With the baseline part, infusion is complete after 112 minutes, the peak part temperature is reached after 112 minutes, and the part requires 72 minutes to cool down to a temperature of 53° C. In total, the baseline part requires 296 minutes of cycle time. Using the CTC, infusion is complete in 84 minutes, the peak part temperature is reached after 64 minutes, and the part requires a cool down period of 72 minutes to reach a temperature of 47° C., a temperature that is 6 degrees Centigrade cooler than the temperature reached by the baseline part. The total elapsed time using the CTC is 220 minutes. Thus, using the CTC, the cycle time is decreased by 76 minutes. This is a decrease in cycle time of 25%.

1. A compliant cover for placing over a part being molded in a molding process, the cover comprising:
at least one inflatable cell
at least one communication port coupled to the at least one inflatable cell; and,
a source of fluid media at a preselected temperature coupled to the communication port; whereby the inflatable cell may be filled with the fluid media at the preselected temperature and whereby the compliant cover may be used to heat or cool the part being molded.

2. The compliant cover of claim 1 further comprising:
at least one vent opening coupled to the at least one inflatable cell, whereby fluid media coupled to the cell may be vented to atmosphere.

3. The compliant cover of claim 2 further comprising:
a vent flap for selectively covering all or part of the vent opening, whereby the flow of fluid media from the vent openings may be selectively controlled.

4. The compliant cover of claim 1 further comprising:
a first set of stiffening ribs coupled to the compliant cover, the first set of stiffening ribs having the shape of the part being molded, whereby the first set of stiffening ribs assists in holding the compliant cover in the shape of the part being molded.

5. The compliant cover of claim 4 further comprising:
a second set of stiffening ribs, the second set of stiffening ribs extending beyond the edges of the compliant cover and functioning as handles that may be used to position the compliant cover over the part being molded.

6. The compliant cover of claim 1 further comprising:
a plurality of inflatable cells positioned next to one another, wherein the compliant cover comprises the plurality of inflatable cells.

7. The compliant cover of claim 6 further comprising:
at least one communication port coupled to each of the inflatable cells; and,
a supply duct of fluid media at a preselected temperature coupled to each of the communication ports; whereby the inflatable cells may be filled with the fluid media at the preselected temperature and whereby the compliant cover may be used to heat or cool the part being molded.

8. The compliant cover of claim 7, wherein the inflatable cells extend for the length of the compliant cover.

9. The compliant cover of claim 7 further comprising:
an interior transverse separator wall positioned along the length of the compliant cover, the transverse separator wall dividing the interior of the compliant cover into two or more longitudinally spaced inflatable cells, whereby the inflatable cells extend for only a portion of the length of the compliant cover.

10. The compliant cover of claim 9 further comprising:
at least one communication port coupled to each of the longitudinally spaced inflatable cells; and,
a second supply duct of fluid media at a preselected temperature coupled to each of the communication ports; whereby the longitudinally spaced inflatable cells may be filled with the fluid media at different preselected temperatures.

11. The compliant cover of claim 1 further comprising:
at least one vent opening coupled to each of the inflatable cells, whereby fluid media coupled to the cells may be vented to atmosphere.

12. The compliant cover of claim 6 further comprising:
a hinge portion having a hinge line formed between at least two of the cells, wherein the part being molded has a longitudinal axis and the inflatable cells have a longitudinal axis that is parallel to the longitudinal axis of the part, and wherein the hinge line is oriented along the longitudinal axis of the inflatable cells, whereby the hinge portion allows the position of the longitudinal cells to change relative to one another by folding along the hinge line to allow the compliant cover to be placed in position in the mold in a folded condition to be in contact with only a portion of the part being molded, and thereafter be opened to be in contact with substantially all of the part being molded.

13. The compliant cover of claim 12, wherein the cells have an elongated shape and the hinge is positioned along the elongated sides of two of the cells.

14. The complaint cover of claim 8 wherein the elongated cells are aligned along the elongated axis of the mold.

15. The compliant cover of claim 1 wherein the materials used to form the compliant cover are chosen to rapidly transmit the temperature of the thermal media in the cells to the part being molded.
